(19) United States
(12) Patent Application Publication
(10) Pub. No.: US 2004/0145917 A1
(43) Pub. Date: Jul. 29, 2004

(54) Integrated power supply circuit for simplified boad design

(76) Inventor: William R. Eisenstadt, Gainesville, FL (US)

Correspondence Address: AKERMAN SENTERFITT, P.O. BOX 3188, WEST PALM BEACH, FL, 33402-3188, US

(21) Appl. No.: 10/677,596

(22) Filed: Oct. 2, 2003

Related U.S. Application Data
(60) Provisional application No. 60/415,618, filed on Oct. 2, 2002.

(51) Int. Cl. H02J 1/00; H02M 3/00

(52) U.S. Cl. 363/15

(57) ABSTRACT

An integrated circuit which includes at least one DC to DC converter for receiving a supply voltage level and producing at least one intermediate voltage level which is greater than the supply voltage level. The integrated circuit also includes processing circuitry for receiving at least one time-varying input voltage signal and increasing a level of the time-varying voltage signal. The processing circuitry can include analog or digital circuitry or a combination of both analog and digital circuitry, and the time-varying input voltage signal can be an analog signal or a digital signal. The integrated voltage boost power supply can output the increased time-varying voltage signal and a plurality of DC voltages.

### CROSS-REFERENCE TO RELATED APPLICATIONS

The present application claims the priority of provisional U.S. patent application No. 60/415,618 entitled Integrated Voltage Boost Circuit for Simplified Board Design, filed Oct. 2, 2002.

### STATEMENT REGARDING FEDERALLY SPONSORED RESEARCH OR DEVELOPMENT

(Not applicable)

### BACKGROUND OF THE INVENTION

1. Field of the Invention

The invention relates to integrated circuits and, more particularly, to integrated power supply circuits.

2. Description of the Related Art

Most modern circuit board designs contain multiple integrated circuits (IC's) from a wide variety of vendors. Oftentimes these IC's have differing supply voltage requirements. For example, a digital electronics board may incorporate an IC requiring a supply voltage of 5.0 volts, another IC requiring 3.3 volts, another IC requiring 2.0 volts and so on. The output voltages of such IC's also can differ depending on circuit requirements. For example, peripheral devices to which the IC's are often coupled can require multiple interface voltages. Such devices can include, for example, liquid crystal displays (LCD's), keyboards, modems and disk drives. Further, many external connectors to which IC's may be interfaced require specific minimum voltage levels to maintain sufficient signal-to-noise ratios. The minimum voltage levels can vary, however, depending on the type of connector which is used.

In view of the variety of supply and output voltages often required on a circuit board, it is frequently required that a circuit be provided with multiple supply voltages. Oftentimes, each voltage supply is provided with an independent voltage regulator, passive filter elements and/or extra IC's for converting a first supply voltage to a plurality of different supply voltages. Although this solution is effective, providing multiple supply voltages in such a fashion is costly, increases design complexity and consumes large areas of board space.

### SUMMARY OF THE INVENTION

The present invention relates to an integrated power supply circuit (integrated circuit). The integrated circuit includes at least one DC to DC converter. The DC to DC converter can include a switched capacitor. The DC to DC converter can receive a supply voltage and produce at least one intermediate voltage. The integrated circuit also can include processing circuitry for receiving at least one time-varying input signal and modifying a parameter of the time-varying input signal. The processing circuitry also can receive an intermediate voltage produced by the DC to DC converter.

At least one of the intermediate voltages can have a voltage level that is greater than a voltage level of the supply voltage. Further, the integrated circuit can have a plurality of outputs, for example for providing voltages having different voltage levels. For instance, an output voltage level a first output can be greater than an output voltage level of a second output. The output voltages can be DC or time-varying.

A voltage level and/or a frequency of the time-varying signal can be increased or decreased. Thus, the integrated circuit provides a plurality of DC output voltages and the time-varying signal having increased voltage and/or frequency. In one arrangement, the processing circuitry can include digital circuitry, analog circuitry or a combination of analog and digital circuitry.

The time-varying input signal can be a digital signal or an analog signal, for example a radio frequency signal or a microwave signal. The processing circuitry can include an input buffer and an output buffer. The processing circuitry also can include a frequency multiplier. In another arrangement, the integrated circuit can include at least one passive element for providing programmability to the intermediate voltage level. Further, the parameter of the time-varying signal that is modified by the processing circuitry can be programmable.

The present invention also concerns a circuit board. The circuit board can include a plurality of integrated circuits disposed on the board. The integrated circuits can require a plurality of voltage levels and signals for operation. The circuit board also can include an integrated circuit that has at least one DC to DC converter for receiving a supply voltage and producing at least one intermediate voltage. The level of the intermediate voltage can be greater than the supply voltage. Further, the integrated circuit can include processing circuitry for receiving at least one time-varying input signal and modifying a parameter of the time-varying signal. The processing circuitry also can receive the intermediate voltage. The integrated circuit can provide all of the voltage levels and signals required for operation of the plurality of integrated circuits.

### BRIEF DESCRIPTION OF THE DRAWINGS

A fuller understanding of the present invention and the features and benefits thereof will be accomplished upon review of the following detailed description together with the accompanying drawings, in which:

FIG. 1 illustrates an integrated circuit in accordance with the inventive arrangements.

FIG. 2 illustrates an alternative integrated circuit in accordance with the inventive arrangements.

FIG. 3 illustrates a circuit board in accordance with the inventive arrangements.

FIG. 4 illustrates one example of a DC to DC converter in accordance with the inventive arrangements.

FIG. 5 illustrates one example of a processing circuit in accordance with the inventive arrangements.

FIG. 6 illustrates another example of a processing circuit in accordance with the inventive arrangements.

FIG. 7 illustrates yet another example of a processing circuit in accordance with the inventive arrangements.

FIG. 8 illustrates an example of a processing circuit in which the outputs of the processing circuit are programmable in accordance with the inventive arrangements.

### DETAILED DESCRIPTION OF THE INVENTION

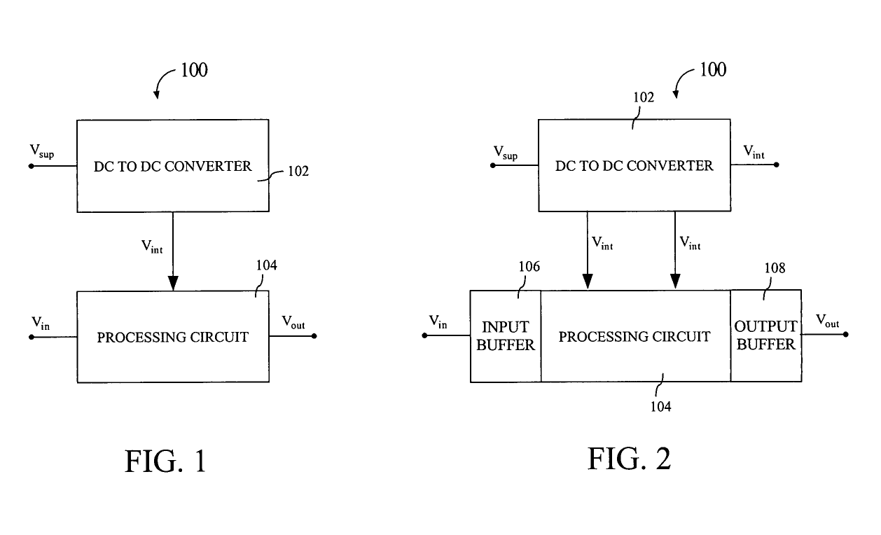

Referring to FIG. 1, an exemplary integrated power supply circuit (integrated circuit) 100 in accordance with the inventive arrangements is shown. For purposes of the invention, the term “integrated” refers to the respective components being formed on or in a common integrated circuit (“IC chip”) or a common substrate material, such as silicon. The integrated circuit 100 can generate one or more suitable supply voltages and can process one or more time-varying signals. The term “process” or “processing” includes modifying the frequency and/or signal amplitude.

As an example, the integrated circuit 100 can include a DC to DC converter 102 and a processing circuit 104. As shown, the DC to DC converter 102 can receive one or more supply voltage levels Vₛᵤₚ as a relatively low voltage and can produce at least one intermediate voltage level Vᵢₙₜ from the supply voltage level Vₛᵤₚ received. In one arrangement, at least one of the produced intermediate voltage levels Vᵢₙₜ can be greater than the supply voltage level Vₛᵤₚ from which it is generated. The invention is not limited in this regard, as the intermediate voltage level Vᵢₙₜ can be a voltage that is lower than, equal to or with a reversed polarity as compared to the supply voltage level Vₛᵤₚ.

The processing circuit 104 can receive one or more time-varying input voltage Vᵢₙ signals and can process and output these signals. For example, the processing circuit 104 can vary one or more particular characteristics or parameters of the time-varying input voltage Vᵢₙ signals to produce an output voltage Vₒᵤₜ signal. In particular, the processing circuit can produce an output voltage Vₒᵤₜ signal having a different frequency or amplitude than the input voltage Vᵢₙ. For instance, the frequency of the output voltage Vₒᵤₜ signal can be lower or higher than the frequency of the input voltage Vᵢₙ signal. Similarly, the voltage level of the output voltage Vₒᵤₜ signal can be lower or higher than the voltage level of the input voltage Vᵢₙ signal. It is understood, however, that the invention is not limited to processing these particular parameters.

In another arrangement, referring to FIG. 2, the DC to DC converter 102 can provide a plurality of intermediate voltage levels Vᵢₙₜ. This plurality of intermediate voltage levels Vᵢₙₜ can be used to provide supply voltages to other suitable circuits or components within the processing circuit 104, or external to the processing circuit 104. As such, the integrated circuit 100 can provide a plurality of DC output voltages and an output voltage Vₒᵤₜ signal, which is time-varying, having an amplitude and/or frequency different than the input voltage Vᵢₙ signal. Referring to FIGS. 1 and 2, the integrated circuit 100 can also include an input buffer 106 and an output buffer 108, if so desired.

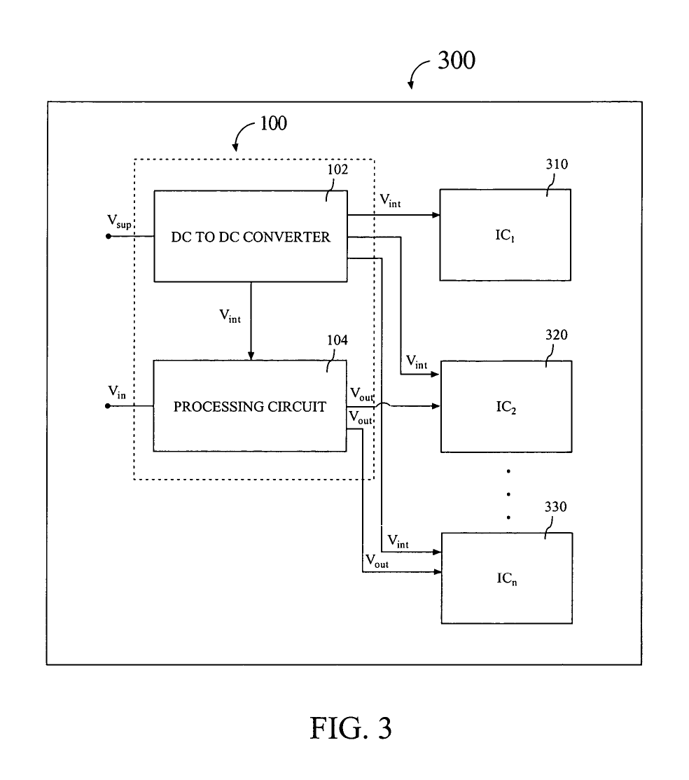

Referring to FIG. 3, a circuit board 300 in accordance with the inventive arrangements is shown. The circuit board 300 can include the integrated circuit 100 (as described in relation to FIG. 1) and one or more other integrated circuits 310, 320, 330. The integrated circuits 310, 320, 330 can require one or more supply voltages and signals for operation, each of which can be provided by the integrated circuit 100.

For example, the integrated circuits 310, 320, 330 may need a DC supply voltage and a processed time-varying voltage signal. The integrated circuit 100 can supply the DC supply voltages through intermediate voltage levels Vᵢₙₜ and the processed time-varying voltage signals through the output voltage Vₒᵤₜ signals. It is understood, however, that the invention is not limited to this example, as the integrated circuit 100 can provide other suitable voltages and/or signals to the integrated circuits 310, 320, 330.

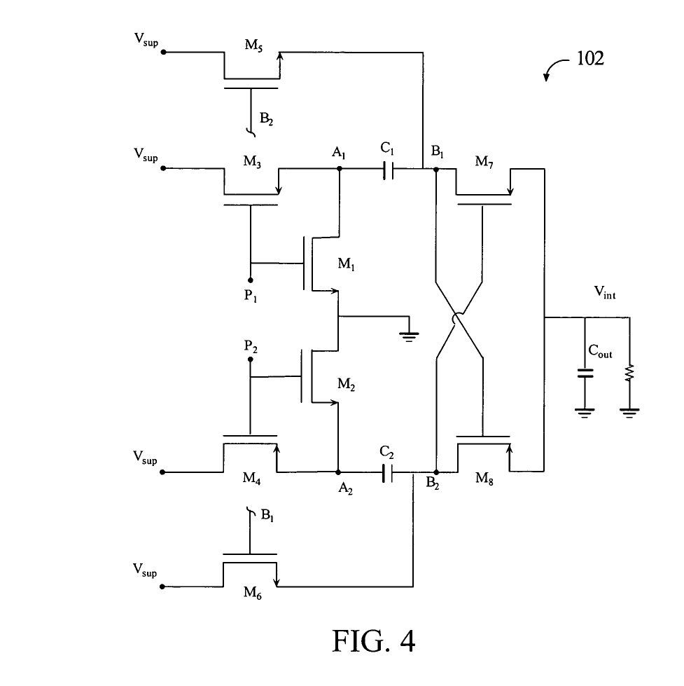

An exemplary DC to DC converter 102 which can be fabricated using standard integrated circuit processing is illustrated in FIG. 4. In this embodiment, the DC to DC converter 102 can be switched capacitor-based, which is an inductorless DC to DC converter. As is known in the art, a switched capacitor DC to DC converter can comprise a plurality of switches and energy transfer capacitors in the power stage. The invention, however, is not limited in this regard, as any other suitable DC to DC converter may be used in the integrated circuit 100 (see FIG. 1), including those containing inductors.

The DC to DC converter 102 can include NMOS transistors M₁, M₂, M₅, M₆ and PMOS transistors M₃, M₄, M₇, M₈. Further, the gates of transistors M₅, M₇ can be cross-coupled to node B₂, and the gates of transistors M₆, M₈ can be cross-coupled to node B₁. Gate drive inputs P₁ and P₂ can be opposite phase clock signals with a high value approximately equal to the supply voltage Vₛᵤₚ and a low value roughly equal to zero. The DC to DC converter 102 also can include capacitors C₁, C₂, Cₒᵤₜ, with Cₒᵤₜ being an output filter capacitor. In one arrangement, capacitors C₁, C₂ can be constructed as parallel-plate capacitors using two polysilicon layers separated by a layer comprising silicon dioxide in a double-poly CMOS process. Those of ordinary skill in the art, however, will appreciate that other suitable types of capacitors can be used with the DC to DC converter 102.

In operation, at one instance, gate drive input P₁, for example, can be high (or ≈supply voltage Vₛᵤₚ) and gate drive input P₂ can be low (or ≈zero volts). In this state, transistor M₃ will be off and transistor M₁ will be on, which causes the voltage at node A₁ to be slightly above zero. Additionally, with gate drive input P₂ low, transistor M₄ turns on and transistor M₂ turns off, which can increase the voltage at node A₂ to nearly the supply voltage Vₛᵤₚ. As a result, assuming a previous half-cycle where capacitor C₂ was charged up to the supply voltage Vₛᵤₚ, the voltage at node B₂ can be raised to about twice the value of the supply voltage Vₛᵤₚ (i.e., 2Vₛᵤₚ).

Because the voltage at node B₂ is at twice the supply voltage Vₛᵤₚ, transistor M₅ (whose gate is coupled to node B₂) turns on, thereby bringing the voltage at node B₁ to a value roughly equal to the supply voltage Vₛᵤₚ. Thus, the capacitor C₁ can be charged to a value equal to or around the supply voltage Vₛᵤₚ through transistors M₅ and M₁. Transistor M₁ is turned on because the gate of transistor M₁ is coupled to gate drive input P₁, which is at Vₛᵤₚ. The resultant voltages on the nodes B₁ (≈Vₛᵤₚ) and B₂ (≈2Vₛᵤₚ) cause transistor M₈ to turn on, which causes the intermediate voltage level Vᵢₙₜ to increase to approximately twice the supply voltage 2Vₛᵤₚ through transistors M₄ and M₈. In the meantime, because its gate voltage is coupled to node B₂ (=2Vₛᵤₚ) and the voltage at node B₁ is around the supply voltage Vₛᵤₚ, transistor M₇ will turn off.

In the opposite phase, gate drive input P₂ can be high (≈the supply voltage Vₛᵤₚ) and gate drive input P₁ can be low (≈zero volts). Transistor M₃ turns on, and transistor M₁ turns off, which can bring node A₁ up to the supply voltage Vₛᵤₚ. As a result, the voltage at node B₁ can reach roughly twice the supply voltage Vₛᵤₚ (a charge equal to the supply voltage Vₛᵤₚ was already present from the previous charge cycle). In the meantime, transistor M₆ will turn on because its gate is coupled to node B₁, which can bring the voltage at node B₂ to approximately Vₛᵤₚ. As the gate for transistor M₇ is coupled to node B₂ (which is ≈Vₛᵤₚ) and the voltage at node B₁ is roughly twice the supply voltage Vₛᵤₚ, transistor M₇ will turn on, and the intermediate voltage level Vᵢₙₜ can be twice the supply voltage Vₛᵤₚ.

Additionally, transistor M₈ will turn off because its gate is coupled to node B₁, and as noted earlier, the voltage at node B₂ is around Vₛᵤₚ. Capacitor C₂ can be charged to a value equal to or around the supply voltage through transistors M₂ and M₆. Transistor M₂ is turned on in this phase because the gate of transistor M₂ is connected to the gate drive input P₂, which is at roughly the supply voltage Vₛᵤₚ.

The above discussion illustrates merely one example of a DC to DC converter 102 that can produce an intermediate voltage level Vᵢₙₜ that is approximately equal to twice the supply voltage Vₛᵤₚ. It is understood, however, that the invention is not limited in this regard, as any other suitable DC to DC converter can be used to produce the intermediate voltage levels Vᵢₙₜ, including an inductor-based circuit. For example, a voltage tripler (a DC to DC converter that can produce an output that is about three times a supply voltage) can be used with the invention. Converter stages can also be cascaded to realize higher gains. In addition, DC to DC converters that produce multiple outputs of various voltages can also be implemented into the integrated circuit 100 (see FIG. 1). Of course, the invention is not limited to a DC to DC converter that increases voltage, as converters that decrease voltage can be used. Moreover, converters that merely invert the polarity of a supply voltage also can be used.

Referring once again to FIG. 4, in one arrangement, the DC to DC converter 102 can be programmable. As an example, additional PMOS transistors may be added after the supply voltage Vₛᵤₚ such that a PMOS transistor can be in series with transistor M₃, one in series with transistor M₄, one in series with transistor M₅ and another one in series with transistor M₆. A programmable bias voltage may be applied to the gates of the additional PMOS transistors so that the values of the voltages applied to the drains of transistors M₃, M₄, M₅ and M₆ can be reduced by a controlled amount. The output Vᵢₙₜ then can be lowered by a programmed amount. Additionally, and as known in the art, other peripheral passive elements, such as resistors, capacitors or inductors that are external to the integrated circuit 100, can provide programmability of the intermediate voltage levels Vᵢₙₜ.

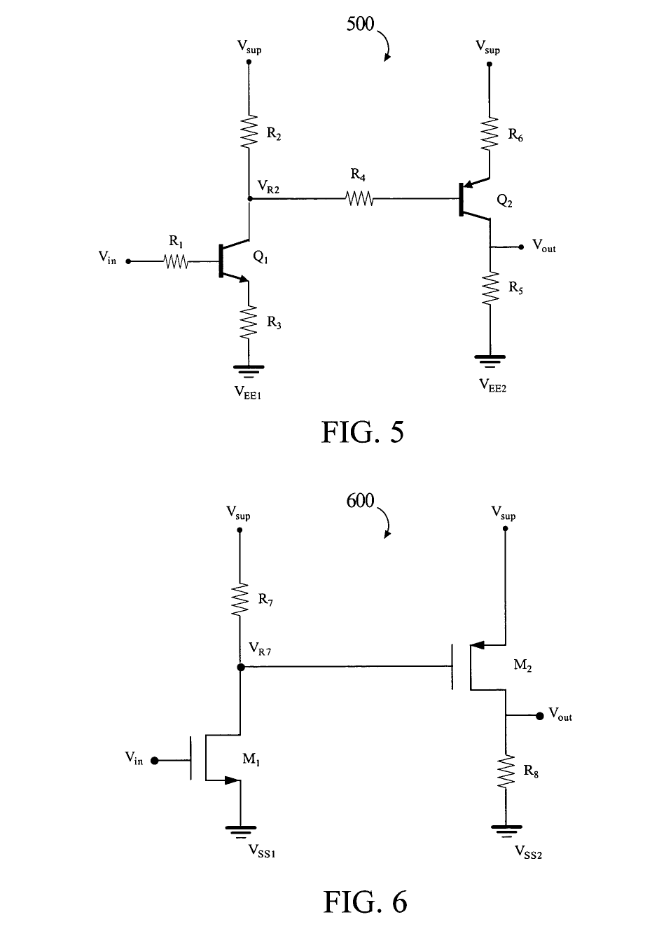

The processing circuit 104 of the integrated circuit 100 of FIG. 1 can be any circuit suitable for processing one or more time-varying input signals and outputting one or more modified signals. Referring to FIG. 5, an example of such a suitable circuit is shown. In this example, the processing circuit 104 of FIG. 1 can be a bipolar voltage translation circuit (translation circuit) 500 for processing digital signals. The time-varying input signal can be a low voltage logic input Vᵢₙ signal, and the translation circuit 500 can output this signal as a high voltage logic output Vₒᵤₜ signal. The translation circuit 500 can also require a relatively large supply voltage Vₛᵤₚ, which can be provided by the intermediate voltage levels Vᵢₙₜ generated by the DC to DC converter 102 of FIG. 4.

The translation circuit 500 can include an NPN transistor Q₁ and a PNP transistor Q₂. Resistor R₁, located in series with the base of transistor Q₁, can protect transistor Q, by the limiting the base current flowing into the base of transistor Q₁. Resistor R₂ can permit current flow through the collector of transistor Q₁, which can generate a voltage at V_{R2} sufficient to turn on transistor Q₂. In addition, resistor R₃ can control, at least in part, the current flow through transistor Q₁ and can stabilize the operation of the transistor Q₁ with temperature.

Resistor R₄ can protect transistor Q₂ by limiting the amount of current in the base of transistor Q₂. Also, resistor R₅ can set the amount of current in the collector of transistor Q₂ when transistor Q₂ is on. Finally, resistor R₆, similar to resistor R₃, can control, at least in part, the current flow through transistor Q₂ and can stabilize the operation of transistor Q₂ with temperature.

In one arrangement, exemplary values for the low voltage logic input Vᵢₙ signals can be as follows: (1) Vᵢₙ low can be approximately 0 volts to approximately 0.5 volts; and (2) Vᵢₙ high can be any voltage greater than approximately 0.7 volts to approximately 1 volt for silicon bipolar transistors. Nevertheless, other bipolar transistor technologies having different base-emitter forward voltages may be employed in the invention in which these alternative voltage drops can be used in place of the values listed above for the low voltage logic input Vᵢₙ signals. The values for the high voltage logic output Vₒᵤₜ signals can be as follows: (1) Vₒᵤₜ low can be approximately equal to ground voltage or ground; and (2) Vₒᵤₜ high can be approximately equal to the supply voltage Vₛᵤₚ minus the drop in voltage across transistor Q₂ and resistor R₆, which can be roughly within 0.3 volts of Vₛᵤₚ, or the voltage at which transistor Q₂ is saturated if resistor R₆ is set to a very low value.

As those of ordinary skill in the art will appreciate, the value of the resistance provided by resistor R₆ and resistor R₄ can set the maximum of the high voltage logic output Vₒᵤₜ signal to a lower value, if so desired. Additionally, the translation circuit 500 is not limited to the values listed above, as they are merely examples and other suitable high and low values for transistor operation can be used. In one embodiment, the supply voltage associated with the emitter of transistor Q₁, or V_{EE1}, can be equal to ground, and the supply voltage associated with the collector of transistor Q₂, or V_{EE2}, can be equal to ground as well. As will be explained below, the value for the low voltage logic input Vᵢₙ signal can be adjusted by modifying the value of V_{EE1}.

In operation, the translation circuit 500 can receive its supply voltage Vₛᵤₚ from the DC to DC converter 102 (see FIG. 4), and as an example, the low voltage logic input Vᵢₙ signal can be applied low, such as near ground. As a result, transistor Q₁ turns off, and the voltage across resistor R₄ can increase to the supply voltage Vₛᵤₚ. This increase in voltage is translated to the base of transistor Q₂, which turns it off. Thus, the current through the collector of transistor Q₂ can be roughly 0 amps, which causes the current through resistor R₅ to be about 0 amps, and the high voltage logic output Vₒᵤₜ can be approximately equal to ground.

In contrast, when the low voltage logic input Vᵢₙ signal is high (such as approximately equal to 0.8 volts), transistor Q₁ will turn on thereby allowing current to flow through resistor R₂. At node V_{R2}, the voltage can drop, which causes the base-emitter voltage of transistor Q₂ to drop thereby turning on transistor Q₂. When transistor Q₂ is on, current can flow through the collector of transistor Q₂ and through resistor R₅. This current flow can cause the high voltage logic output Vₒᵤₜ signal to increase to a value close to the supply voltage Vₛᵤₚ (as noted earlier, this value can be the supply voltage Vₛᵤₚ minus roughly 0.3 volts). As a result, the high voltage logic output Vₒᵤₜ signal can swing from roughly ground to a value close to the supply voltage Vₛᵤₚ.

For a reduced input operation, V_{EE1} can be reduced below ground, which will decrease the input voltage needed to turn on transistor Q₁. For example, if the voltage typically required to turn on transistor Q₁ is roughly 0.8 volts (with V_{EE1} approximately equal to ground) and the value of V_{EE1} is reduced below ground, the new value for the low voltage logic input Vᵢₙ signal needed to turn on transistor Q₁ can be approximately 0.8 volts minus the magnitude, or absolute value, of the voltage of V_{EE1}.

Likewise, the translation circuit 500 can be operated under an increased input operation in which V_{EE1} can be raised above ground. This increase in V_{EE1} can cause the low voltage logic input Vᵢₙ required to turn on transistor Q₁ to be approximately 0.8 volts plus the magnitude of the voltage of V_{EE1} (assuming the voltage typically required to turn on transistor Q₁ is 0.8 volts).

Referring to FIG. 6, another example of the processing circuit 104 of FIGS. 1 and 2 is illustrated. In this example, the processing circuit can be a CMOS voltage translation circuit (CMOS translation circuit) 600 for processing and outputting digital signals. Similar to the processing circuit discussed in relation to FIG. 5, the CMOS translation circuit 600 of FIG. 6 can require a relatively large supply voltage Vₛᵤₚ, which can be supplied by the intermediate voltage levels Vᵢₙ produced by the DC to DC converter 102 of FIG. 4. Moreover, the time-varying input signal can be a low voltage logic input Vᵢₙ signal, which the processing circuit 104 can output as a high voltage logic output Vₒᵤₜ signal.

The CMOS translation circuit 600 can include an NFET (n-channel) transistor M₁ and a PFET (p-channel) transistor M₂. Resistor R₇ can set the amount of current flow through the drain of transistor M₁ and can set a voltage to enable transistor M₂ to turn on or off. In addition, resistor R₈ can set the amount of current flow through the drain of transistor M₂. In one arrangement, the low value of the low voltage logic input Vᵢₙ signal can be approximately equal to ground, and the high value of the low voltage logic input Vᵢₙ signal can be any voltage that is greater than the threshold voltage of transistor M₁.

Further, the low value of the high voltage logic output Vₒᵤₜ signal can be approximately equal to ground, and the high value of the high voltage logic output Vₒᵤₜ signal can be close to the supply voltage Vₛᵤₚ; for example, this high value can be roughly equal to the supply voltage Vₛᵤₚ minus the saturation voltage of transistor M₂. In another arrangement, V_{SS1} and V_{SS2} can be approximately equal to ground.

In operation, the CMOS translation circuit 600 can receive its supply voltage Vₛᵤₚ from the DC to DC converter's 102 intermediate voltage levels Vᵢₙₜ. If, for example, the low voltage logic input Vᵢₙ signal is low (approximately equal to ground), transistor M₁ turns off, and the voltage at node V_{R1} can increase to about the supply voltage Vₛᵤₚ. This increase in voltage at node V_{R1} causes transistor M₂ to turn off, which causes the current flowing through resistor R₂ to be approximately 0 amps. As such, the value of the high voltage logic output Vₒᵤₜ signal can be around ground.

Conversely, if the low voltage logic input Vᵢₙ signal is raised to a voltage above the threshold voltage for transistor M₁, then transistor M₁ can turn on. When transistor M₁ is on, drain current can be conducted through resistor R₁. As a result, the voltage at node V_{R7} can drop below the supply voltage Vₛᵤₚ by a drop caused by the drain current flowing through resistor R₇. This drop can be made large enough to cause transistor M₂ to turn on, which can lead to the conduction of drain current through resistor R₈. Thus, the high voltage logic output Vₒᵤₜ signal can increase to a value close to the supply voltage Vₛᵤₚ (such as Vₛᵤₚ minus the saturation voltage of transistor M₂). For reduced input operation, V_{SS1} can be reduced below the value for ground, which can lower the voltage required to turn on transistor M₁. Alternatively, V_{SS1} can be increased above the value for ground to raise the amount of voltage needed to turn on transistor M₁.

It is understood that the invention is not limited to the examples of the processing circuits described in relation to FIGS. 5 and 6, as any other suitable circuit capable of receiving one or more time-varying input voltage signals, processing the signals and outputting the signals, can be used with the invention. Specifically, referring again to FIGS. 1 and 2, the processing circuit 104 also can be a circuit capable of processing analog signals or a combination of analog and digital signals. Moreover, as noted, the processing circuit 104 is not limited merely to increasing the voltage of a time-varying input voltage signal, as the processing circuit also can reduce the voltage or reverse the polarity of the input signal. Finally, the processing circuit is not restricted to modifying the voltage of the time-varying input voltage signals, as other parameters of the input signal, such as the frequency thereof, can be altered.

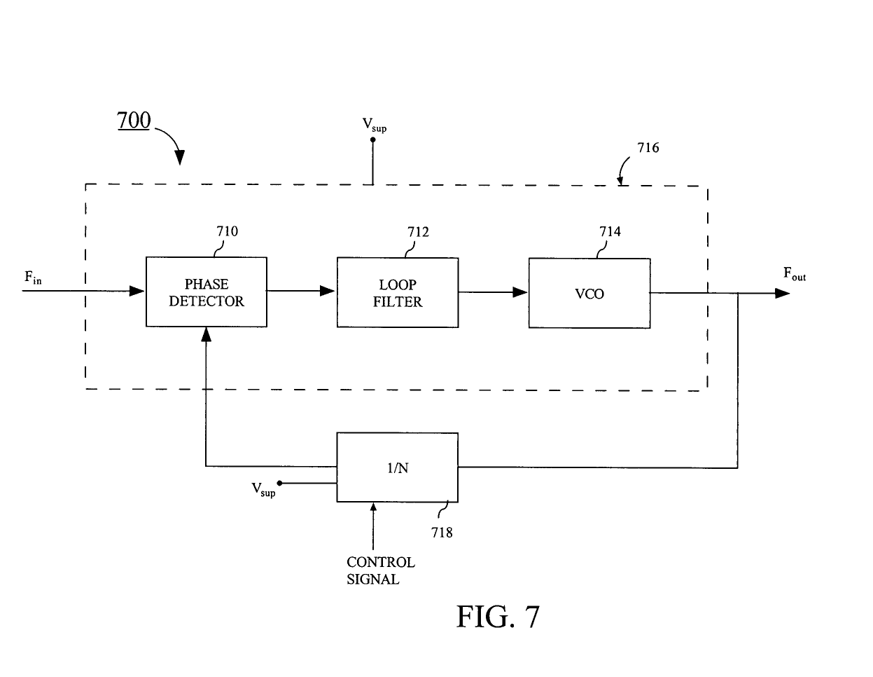

For instance, the processing circuit 104 can include a frequency multiplier for modifying the frequency of an input signal. One example of a frequency multiplier is depicted in FIG. 7. The frequency multiplier can be used to increase or decrease a frequency of a signal. Notably, the processing circuit can be provided with programmability to control the operation of the frequency multiplier.

As shown, a frequency multiplier 700 can include a phase detector 710, a loop filter 712, a voltage-controlled oscillator (VCO) 714 and a divide-by-N counter 718. The phase detector 710, the loop filter 712 and the VCO 714 can be considered part of a phase-locked loop (PLL) circuit 716. Similar to the translation circuits of FIGS. 5 and 6, the intermediate voltage levels Vᵢₙₜ generated by the DC to DC converter 102 (see FIG. 4) can provide the supply voltage Vₛᵤₚ to the PLL circuit 716 and the divide-by-N counter 718.

Although the operation of PLL circuits is well known, a brief description will nonetheless be given. The phase detector 710 can generate a voltage that is proportional to the phase difference between the input frequency Fᵢₙ and the output of the divide-by-N counter 718. As an example, the input frequency Fᵢₙ can be an analog frequency signal such as a radio frequency (RF) signal. For purposes of the invention, an RF signal can be any electromagnetic wave propagated through a suitable medium. The output of the phase detector 710 can be fed to the loop filter 712, which can determine the dynamic characteristics of the PLL circuit 716. The filtered signal exiting the loop filter 712 can control the VCO 714, and the output frequency Fₒᵤₜ can be at a frequency that is “N” times (from the divide-by-N counter 718) the input frequency Fᵢₙ. A control signal can be fed to the divide-by-N counter 718 to control the level of frequency multiplication, or the value of Fₒᵤₜ. Those of ordinary skill in the art, however, will appreciate that the invention is not so limited and other suitable circuits can be used to modify the frequency of an input signal and generate an output signal.

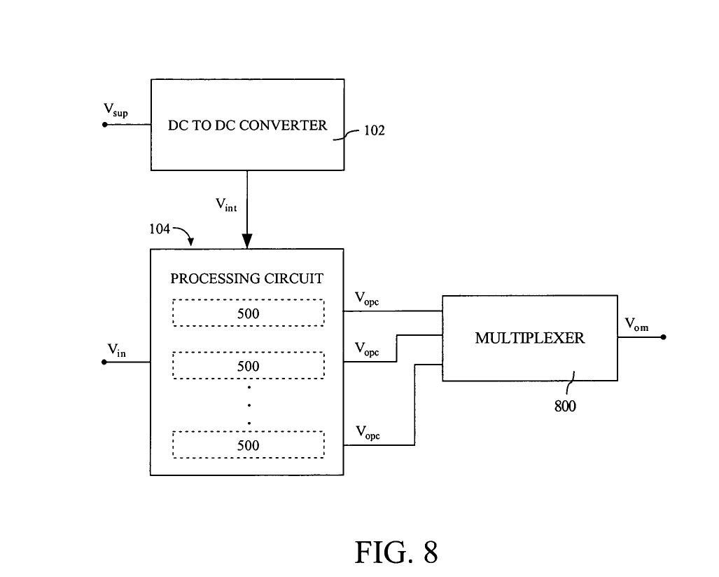

In another embodiment, the output signals produced by the processing circuit 104 of FIGS. 1 and 2 can be programmable. Referring to FIG. 8, an example of such a process is illustrated. To explain this concept, the processing circuit can incorporate the translation circuit 500 configuration of FIG. 5. In one arrangement, a plurality of these translation circuits 500, represented by the boxes having dashed outlines, can produce any number of output voltages V_{opc}. Although the translation circuit was described as outputting logic signals, the output voltages here, in view of the invention's capability of processing all types of signals, will be generically referred to as output voltages. A similar principle applies to the input voltages, which can be referred to as Vᵢₙ.

The output voltages V_{opc} can be analog or digital outputs of various voltage levels. The output voltages V_{opc} can be fed to a multiplexer 800. The multiplexer 800 can receive any suitable number of control signals for controlling the output of the multiplexer 800. Because the output voltages V_{opc} can comprise many different voltage levels, these control signals can provide programmability which can be used to program the multiplexer 800 for generating a multiplexer output voltage Vₒₘ.

It is to be understood that while the invention has been described in conjunction with the preferred specific embodiments thereof, that the foregoing description as well as the examples which follow are intended to illustrate and not limit the scope of the invention. Other aspects, advantages and modifications within the scope of the invention will be apparent to those skilled in the art to which the invention pertains.

What is claimed is:

1. An integrated circuit, comprising:
at least one DC to DC converter for receiving a supply voltage and producing at least one intermediate voltage, at least one of said intermediate voltages having a greater voltage level than said supply voltage; and
processing circuitry for receiving at least one time-varying input signal and modifying a parameter of said time-varying signal to produce a modified time-varying signal.

2. The integrated circuit of claim 1, wherein said processing circuitry further receives said intermediate voltage having a greater voltage level than said supply voltage.

3. The integrated circuit of claim 1, wherein said parameter is selected from the group consisting of a voltage level and a frequency.

4. The integrated circuit of claim 1, wherein said modification is selected from the group consisting of increasing said parameter and decreasing said parameter.

5. The integrated circuit of claim 1, wherein said processing circuitry comprises digital circuitry.

6. The integrated circuit of claim 1, wherein said processing circuitry comprises analog circuitry.

7. The integrated circuit of claim 1, wherein said processing circuitry comprises analog and digital circuitry.

8. The integrated circuit of claim 1, wherein said time-varying input signal is a digital signal.

9. The integrated circuit of claim 1, wherein said time-varying input signal is an analog signal.

10. The integrated circuit of claim 1, wherein said parameter of said time-varying signal that is modified by said processing circuitry is programmable.

11. The integrated circuit of claim 1, wherein said processing circuitry comprises an input buffer and an output buffer.

12. The integrated circuit of claim 1, further comprising at least one passive element for providing programmability to said at least one intermediate voltage.

13. The integrated circuit of claim 12, wherein said at least one passive element is a peripheral passive element.

14. The integrated circuit of claim 1, wherein said DC to DC converter is switched capacitor based.

15. The integrated circuit of claim 1, wherein said integrated circuit further comprises a plurality of outputs, wherein an output voltage level a first of said outputs is greater than an output voltage level of a second of said outputs.

16. The integrated circuit of claim 1, wherein said output voltage of said first output is a DC voltage greater than said supply voltage.

17. A circuit board, comprising:
a plurality of integrated circuits disposed on said board, said plurality of integrated circuits requiring a plurality of voltage levels and signals for operation; and
an integrated power supply circuit disposed on said board, said integrated power supply circuit comprising:
at least one DC to DC converter for receiving a supply voltage and producing at least one intermediate voltage, at least one of said intermediate voltages having a greater voltage level than said supply voltage;
processing circuitry for receiving at least one time-varying input signal and modifying a parameter of said time-varying signal to produce a modified time-1 varying signal; and
a plurality of outputs, wherein an output voltage level a first of said outputs is greater than an output voltage level of a second of said outputs.

18. The circuit board of claim 17, wherein said processing circuitry further receives said intermediate voltage having a greater voltage level than said supply voltage.

19. The circuit board of claim 17, wherein said parameter is selected from the group consisting of a voltage level and a frequency.

20. The circuit board of claim 17, wherein said modification is selected from the group consisting of increasing said parameter and decreasing said parameter.

21. The circuit board of claim 17, wherein said processing circuitry comprises digital circuitry.

22. The circuit board of claim 17, wherein said processing circuitry comprises analog circuitry.

23. The circuit board of claim 17, wherein said processing circuitry comprises analog and digital circuitry.

24. The circuit board of claim 17, wherein said time-varying input signal is a digital signal.

25. The circuit board of claim 17, wherein said time-varying input signal is an analog signal.

26. The circuit board of claim 17, wherein said parameter of said time-varying signal that is modified by said processing circuitry is programmable.

27. The circuit board of claim 17, wherein said processing circuitry comprises an input buffer and an output buffer.

28. The circuit board of claim 17, further comprising at least one passive element for providing programmability to said at least one intermediate voltage.

29. The circuit board of claim 28, wherein said at least one passive element is a peripheral passive element.

30. The circuit board of claim 17, wherein said DC to DC converter is switched capacitor based.

31. The circuit board of claim 17, wherein said output voltage of said first output is a DC voltage greater than said supply voltage.
